(19) United States
(12) Patent Application Publication
(10) Pub. No.: US 2012/0077038 A1
(43) Pub. Date: Mar. 29, 2012

(54) A PROCESS FOR INCORPORATING AN INTERPENETRATING NETWORK OR BLEND INTO THE SURFACE LAYER OF A POLYMERIC ARTICLE

(75) Inventors: Robert A. Pyles, Bethel Park, PA (US); Ronald C. Hedden, Lubbock, TX (US); Daniel M. Lentz, Woodbury, MN (US)

(73) Assignee: Bayer MaterialScience LLC, Pittsburgh, PA (US)

(21) Appl. No.: 12/893,020

(22) Filed: Sep. 29, 2010

(51) Int. Cl. B32B 27/16; B32B 27/00; B32B 27/04; C08J 7/18

(52) U.S. Cl. 428/412; 427/495; 428/422; 428/423.1; 428/475.5; 428/480; 428/521; 428/522

(57) ABSTRACT

The present invention provides a plastic article containing a first polymer and an interpenetrating network or blend of a second polymer infused in a surface layer of the first polymer, wherein the second polymer is the product of photopolymerizing, in a de-oxygenated environment, a reactive monomer in the presence of one or more radical photoinitiators. The present invention also provides a process for the infusion of a surface layer polymer interpenetrating network (“IPN”) or interpenetrating blend (“IPB”) into plastic articles. By inclusion of a second polymer within the pre-existing first polymer, surface modification of the physical and chemical properties of the host polymer may be enhanced.

### FIELD OF THE INVENTION

The present invention relates in general to polymeric articles and processes for the production thereof, and more specifically, to a plastic article containing an interpenetrating network or blend of a polymer infused in a surface layer of the article and to a process for infusing a first polymer into the surface of a plastic article, creating an interpenetrating network (“IPN”) or interpenetrating blend (“IPB”) within the topmost surface layer.

### BACKGROUND OF THE INVENTION

Thermoplastic polyurethanes (“TPUs”) are polymeric materials produced in the simplest sense by condensation of a diol monomer with a diisocyanate in the presence of a catalyst, though numerous formulations incorporating chain extenders and/or mixtures of monomers have been developed and commercialized. Elastomeric thermoplastic polyurethanes generally contain a crystallizable or glassy block but lack covalent crosslinking, allowing them to be processed in the melt state, with solidification resulting from physical crosslinking by crystallization or vitrification. Physical properties of thermoplastic polyurethane elastomers such as elasticity, high elongation at break, impact resistance, light fastness, oxidation and hydrolysis resistance, and low-temperature flexibility have facilitated their widespread commercial production and use in consumer products, medical applications, and military applications.

Enhancement of thermoplastic polyurethane elastomer surface characteristics, such as gas or liquid barrier properties, resistance to cutting, scuffing, chipping, and wear, and ability to damp mechanical/acoustic vibrations, can be achieved by incorporation of a interpenetrating network layer at the surface by various means. For example, U.S. Pat. Nos. 7,157,527; 7,288,604; and 7,339,010 disclose the production of polyurethane interpenetrating network materials for use in golf ball layers by including an epoxy-based or acrylic-based system, wherein the two systems are polymerized or cured simultaneously or sequentially to form an interpenetrating network.

U.S. Pat. Nos. 6,271,305 and 6,538,060 describe interpenetrating network materials for roofing and construction applications developed by in situ reaction of polyols with different isocyanates and polyisocyanates in bituminous material such as asphalt, coal tar, polymer modified asphalt, oxidized, and unoxidized asphalt.

Tomko, in U.S. Pat. No. 6,166,127, provides a method to produce coating compositions said to have superior solvent resistance and film hardness by creating an interpenetrating network of a polyurethane component and a functionalized waterborne polymer.

U.S. Pat. No. 6,153,709, issued to Xiao, et al., discloses an interpenetrating network formulation including a blocked polyurethane prepolymer (or a blocked polyisocyanate and a polyol), an epoxy resin, a filler and a plasticizer. Xiao, et al. also provide a method for forming a chip resistant, vibration damping coating for automotive applications.

Avenel, in U.S. Pat. No. 5,539,053, details high impact-strength cast sheet materials comprised of an interpenetrating network of a major amount of a reticulated methyl methacrylate polymer and from 3% to 8% by weight of an elastomeric polyurethane.

U.S. Pat. No. 5,091,455, issued to Blank, et al., describes interpenetrating networks made by admixing polyols, polyisocyanate, and a polyvinylchloride) plastisol, followed by heating to complete the cure. The resulting polyurethane/poly(vinylchloride) interpenetrating network is said to have superior properties as a sealant, especially for automotive parts.

Physical properties of thermoplastic polyurethanes may also be enhanced by infusion of various compounds from solution. Infusion of coloring agents and functional additives into polymeric matrices and to articles comprising such matrices has been disclosed in U.S. Pat. Nos. 6,749,646; 6,929,666; 7,094,263; 6,733,543: 6,949,127; 6,994,735; and 7,175,675.

A need exists in the art for improved plastic articles containing interpenetrating networks or interpenetrating blends and for better processes to produce such articles.

### SUMMARY OF THE INVENTION

Accordingly, the present invention provides a plastic article containing a first polymer and an interpenetrating network or blend of a second polymer infused in a surface layer of the first polymer, wherein the second polymer is the product of photopolymerizing, in a de-oxygenated environment, a reactive monomer in the presence of one or more radical photoinitiators. The present invention also provides processes for the infusion of a surface layer polymer interpenetrating network (“IPN”) or interpenetrating blend (“IPB”) into plastic articles. In the present context, interpenetrating networks refer to the covalent cross-linking of one polymer network in such a way that it is physically entangled with the covalently cross-linked network of another polymer. The invention also provides variations of these processes to produce interpenetrating blends, in which either the first or second polymer, or both, may be a non-crosslinked polymeric material. By inclusion of a second polymer within the pre-existing first polymer, surface modification of the physical and chemical properties of the host polymer may be enhanced.

The process of the present invention is particularly well suited to, but not limited to, the infusion of various acrylate and methacrylate monomers into thermoplastic polyurethane elastomers, followed by photopolymerization of the monomer in a de-oxygenated environment to produce a surface interpenetrating network or interpenetrating blend of a polyacrylate or polymethacrylate within the thermoplastic polyurethane.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.” As used herein, the term “article” means an article of manufacture, or a semi-finished article in the form of pellets, sheet or rod, that contains a polymeric resin or a resinous composition. The term “surface layer” as used in the context of the present invention means an infused layer extending up to 500 μm beneath the original surface of the plastic article. The term “interpenetrating blend” as used herein includes systems where one component is crosslinked, which have traditionally been termed “semi-interpenetrating networks.”

The present invention provides a plastic article containing a first polymer and an interpenetrating network or blend of a second polymer infused in a surface layer of the first polymer, wherein the second polymer is the product of photopolymerizing, in a de-oxygenated environment, a reactive monomer in the presence of one or more radical photoinitiators.

The present invention also provides a process for producing one of an interpenetrating network and an interpenetrating blend in a surface layer of a plastic article, the process involving contacting the plastic article with a solution containing at least one reactive monomer and one or more radical photoinitiators for a time and at a temperature sufficient to infuse at least a portion of the solution into the surface layer of the plastic article and photopolymerizing the infused solution in a de-oxygenated environment to produce the interpenetrating network or blend in the surface layer of the plastic article.

The present invention further provides a process for producing one of an interpenetrating network pattern and an interpenetrating blend pattern in a surface layer of a plastic article, the process involving contacting the plastic article with a solution containing at least one reactive monomer and one or more radical photoinitiators for a time and at a temperature sufficient to infuse at least a portion of the solution into the surface layer of the plastic article, photo-masking at least a portion of the plastic article and photopolymerizing the infused solution in a de-oxygenated environment to produce the interpenetrating network pattern or interpenetrating blend pattern in the surface layer of the plastic article.

The present invention yet further provides a process for producing one of an interpenetrating network haptic (texture) and an interpenetrating blend haptic (texture) in a surface layer of a plastic article, the process involving contacting the plastic article with a solution containing at least one reactive monomer and one or more radical photoinitiators for a time and at a temperature sufficient to infuse at least a portion of the solution into the surface layer of the plastic article, photo-masking at least a portion of the plastic article and photopolymerizing the infused solution in a de-oxygenated environment to produce the interpenetrating network pattern or interpenetrating blend pattern in the surface layer of the plastic article.

The inventive processes are preferably conducted in the absence of oxygen. The polymeric materials useful in the plastic article in the present invention may be any of the thermoplastic and/or thermoset polymers.

As used herein, the term “thermoplastic polymer” means a polymer that has a softening or melting point, and is substantially free of a three dimensional crosslinked network resulting from the formation of covalent bonds between chemically reactive groups, e.g., active hydrogen groups and free isocyanate groups. Thermoplastic polymers useful in the present invention include those known to the skilled artisan, such as thermoplastic (co)polyesters, thermoplastic (co)polycarbonates, thermoplastic polyesterpolycarbonate copolymers, thermoplastic acrylonitrile-butadiene-styrene copolymers, thermoplastic polyamides, thermoplastic polyurethanes, thermoplastic polyalkyl(meth)acrylate and thermoplastic styrene copolymers.

As used herein, the term “thermoset polymer” means polymers having a three dimensional crosslinked network resulting from the formation of covalent bonds between chemically reactive groups (e.g., active hydrogen groups and free isocyanate groups or oxirane groups; or between unsaturated groups, such as allyl groups). Thermoset polymers typically do not have a melting point. Thermoset polymers which may be used in the present invention include those known to the skilled artisan, such as thermoset (co)polyesters, thermoset (co)polycarbonates, thermoset polyesterpolycarbonate copolymers, thermoset polyamides, thermoset polyurethanes, and thermoset polyalkyl(meth)acrylate.

Among the suitable materials are material systems containing at least one of thermoplastic and thermoset polycarbonates, polyesters, polyester polycarbonate copolymers and blends, polyethylene glycol (“PETG”), polymethylmethacrylate (“PMMA”), (co)polyesters, aliphatic polycarbonate, styrene and styrenic copolymers such as styrene acrylonitrile (“SAN”) and acrylonitrile-butadiene-styrene (“ABS”), acrylic polymers such as polymethylmethacrylate and butylacrylate/SAN resins (“ASA”) polyamide, and polyurethanes and blends of one or more of these resins, nylon, polyvinylalcohols, and plasticized polyvinylchlorides. Particularly preferred in the invention are thermoplastic polyurethanes (“TPUs”) and polycarbonates. The inventive processes are especially suitable for elastomeric substrate materials, such as thermoplastic polyurethane elastomers.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 75 Shore D.

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially unaffected.

Suitable polyester polyols include those prepared by polymerizing ε-caprolactone using an initiator such as ethylene glycol, ethanolamine and the like. Further suitable examples are prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as non-limiting examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic diols containing 2 to 14 carbon atoms, such as ethanediol, 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol-%, based on mots of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for instance, from Bayer MaterialScience under the TEXIN name.

Suitable polycarbonate resins for use in the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See. German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience. Publishers, New York, N.Y., 1964).

In the present context, dihydroxy compounds suitable for the preparation of the polycarbonates of the invention conform to the structural formulae (1) or (2) below.

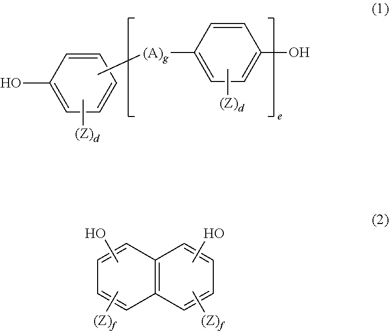

wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

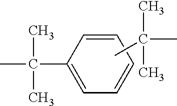

e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(hydroxy-phenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

Polycarbonates useful in the present invention may include in their structure units derived from one or more of the suitable bisphenols.

Among the resins suitable in the practice of the invention are phenolphthalein-based polycarbonate, copolycarbonates and terpoly-carbonates such as are described in U.S. Pat. Nos. 3,036,036 and 4,210,741, both of which are incorporated by reference herein.

The polycarbonates suitable for use in the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften, 1,570,533; 2,116,974 and 2,113,374; British Patents 885,442 and 1,079,821 and U.S. Pat. No. 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethanc; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates useful in the practice of the present invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used. Suitable polycarbonate resins are available in commerce, for instance, from Bayer MaterialScience under the MAKROLON name.

The reactive monomer solution preferably includes 0.01 to 10 mass %, more preferably 0.1 to 3.0 mass % of an ultraviolet light-activated radical photoinitiator compound and 90 to 99.99 mass %, more preferably 97.0 to 99.9 mass % of a monomer polymerizable by such an initiation. The amounts of photoinitiator compound and monomer may range between any of these upper and lower values, inclusive of the recited values.

According to the present invention, the plastic article is treated by contacting at least a portion of its surface with the reactive monomer solution for a time and at temperature sufficient to facilitate at least some infusion of the solution into the article to obtain an infused surface layer, or by immersing the plastic article in the reactive monomer solution for said time.

For infusing plastic articles made of thermoplastic polyurethane, the temperature of the reactive monomer solution is preferably from 20° C. to 80° C. (for polycarbonate preferably from 20° C. to 99° C.), and less than the boiling and/or decomposition temperature of the treatment composition, and less than the deformation/heat deflection temperature of the treated polymer or article.

More preferably, the temperature is from 25° C. to 35° C., and the application time is preferably less than one hour, more preferably less than 20 minutes, most preferably from 0.1 to 20 minutes. The temperature and application time may range between any of these upper and lower values, inclusive of the recited values.

Exposure of the plastic article to broadband ultraviolet light of peak wavelength (254 nm or 365 nm) is conducted at a temperature of preferably 20 to 80° C., for preferably less than 5 minutes to effect polymerization of the infused monomer and form the interpenetrating network or blend at the surface. One key to the inventive process is the intentional exclusion of atmospheric oxygen during ultraviolet exposure to avoid an inhibiting effect on photopolymerization.

For creating a gradient of the infused monomer, the plastic article may be immersed in the reactive monomer solution and gradually withdrawn therefrom at a predetermined rate, to form a gradient of infused precursor, followed by ultraviolet light exposure. The portion of the plastic article remaining in the reactive monomer solution the longest will be impregnated, that is infused, with the highest mass fraction of monomer. Ultraviolet exposure of the material produces a gradient in the surface concentration of the infused polymer.

The radical photoinitiator in the present invention is at least moderately soluble in the chosen monomer or made moderately soluble through chemical modification. Suitable initiators include: 2-hydroxy-1-phenyl-propan-1-one, 1-hydroxy-cyclohexyl-phenyl-ketone, 2-hydroxy-1-{4-[4-(2-hydroxy-2-methyl-propionyl)-benzyl]-phenyl}-2-methyl-propan-1-one, 2-benzyl-2-dimethylamino-1-(4-morpholinophenyl)-butanone-1,2,2-dimethoxy-1,2-diphenylethan-1-one, bis(2,6-dimethoxybenzoyl-2,4,4-trimethyl pentylphosphineoxide, phenylbis(2,4,6-trimethylbenzoyl)-phosphine oxide, 1-[4-(2-hydroxyethoxy)-phenyl]-2-hydroxy-2-methyl-1-propane-1-one, benzophenone, 2-dimethylamino-2-(4-methyl-benzyl)-1-(4-morpholin-4-yl-phenyl)-butan-1-one, 2,2-dimethoxy-1,2-diphenylethan-1-one, oxy-phenyl-acetic acid 2-[2-oxo-2-phenyl-acetoxy-ethoxy]-ethyl ester, oxy-phenyl acetic acid 2-[2-hydroxy-ethoxy]-ethyl ester, bis(2,4,6-trimethylbenzoyl)-phenylphosphineoxide, bis-acyl-phosphine oxide, 2-methyl-1[4-(methylthio)phenyl]-2-morpholinopropan-1-one, 1,2-octanedione, and 1-[4-(phenylthio)phenyl]-, 2-(O-benzoyloxime).

Among the suitable monomers are those capable of being polymerized via free radical polymerization, chiefly acrylate and methacrylate monomers, and blends of two or more such monomers. Particularly preferred in the present invention are acrylic acid, methyl acrylate, n-butyl acrylate, pentaerythritol triacrylate, 1,10-decanediol dimethacrylate, 1,4-butanediol dimethacrylate, n-butoxyethyl methacrylate, cyclohexyl methacrylate, 1,6-hexanediol dimethacrylate, 1,9-decanediol dimethacrylate, diethylaminoethyl methacrylate, dimethylaminoethyl methacrylate, ethylene glycol dimethacrylate, glycidyl methacrylate, isobornyl methacrylate, methyl methacrylate, n-hexyl methacrylate, hydroxyethyl methacrylate, methyl acrylate, 2-hydroxy-3-acryloxy propyl methacrylate, 2-hydroxybutyl methacrylate, 2-hydroxy propyl methacrylate, lauryl methacrylate, perfluorooctylethyl methacrylate, 2-phenoxy ethyl methacrylate, stearyl methacrylate, trifluoroethyl methacrylate, and methacrylic acid.

Reactive monomer formulations containing only mono-acrylates and mono-methacrylates lead to interpenetrating blends in which the poly(acrylate) or poly(methacrylate) component is non-crosslinked. Monomer formulations containing any mole fraction of di-acrylate, tri-acrylate, di-methacrylate, or tri-methacrylate monomers produce crosslinked interpenetrating networks.

According to one embodiment of the present invention, a plastic article, preferably made of thermoplastic polyurethane, is immersed in the reactive monomer solution. The reactive monomer solution, preferably at a temperature that is less than the boiling temperature of the monomer, more preferably less than the melting temperature of the plastic polymer, and most preferably 25 to 35° C., is contacted with the article. The suitable temperature is dependent upon the composition of the plastic article to be treated and may be determined by routine or combinatorial testing. In accordance with this embodiment of the invention, the immersed plastic article is withdrawn after only a few minutes to provide a treated article. The length of time in which the plastic article remains immersed in the bath and the process conditions depends upon the desired degree and depth of infusion of monomer into the surface layer. As those skilled in the art will appreciate, higher temperatures will increase the rate of infusion and depth of penetration. However, care must be taken to not adversely affect the surface properties of transparent articles used in optical applications or to exceed the heat distortion temperature and thus thermally deform the plastic article.

The contacting of the reactive monomer solution to the surface of the plastic article may be by immersing, spraying, or flow-coating to obtain an article containing the reactive monomer mixture in the surface layer (infused article). “Spraying” in the context of the present invention means applying the reactive monomer solution to the plastic article in the form of droplets, fog or mist. The term “flow-coating” as used in the present invention means applying the reactive monomer solution to the article in the form of a continuous liquid film.

The polymerization of the monomer to form an interpenetrating network at the surface may be accomplished by exposing the article to ultraviolet (UV) radiation for some period of time, largely dependent on the intensity of the irradiation provided by the UV source and the UV absorbance of the host polymer. For example, for a UV source providing 20-45 mW/cm², the present inventors have found an irradiation time of 30 seconds to 10 minutes to be useful for thermoplastic polyurethanes, with a time of 1-5 minutes being preferable. It is important that oxygen is mostly, or completely, removed from the environment during UV irradiation of the plastic article due to oxygen's interference with the polymerization process, and due to the safety concerns of avoiding combustible mixtures in spray-coating processes. Deoxygenation can be accomplished in a variety of means, preferably via purging of the processing chamber with an inert gas such as argon, nitrogen, or carbon dioxide.

The present inventors note the UV polymerization aspect of this invention, advantageously, allows for the creation of patterned interpenetrating network or interpenetrating blend layers via photo-masking during UV exposure. For example, the UV irradiation may be screened by a quartz photomask having a chrome-plated pattern on its surface, transferring the pattern to the substrate.

In another embodiment of the inventive process, the reactive monomer solution may be contained in one compartment and the plastic article to be treated may be positioned in another compartment of the same vessel or in a different vessel. The solution may be pumped through suitable dispensers, such as atomizing nozzles or manifolds positioned in the vessel containing the article and inert gas, and applied to the article in a manner calculated to expose a predetermined area of the article to the solution.

In a variation of this embodiment, the first compartment of the vessel may be sized to contain a large article (e.g. sheet) and equipped with a plurality of nozzles or dispensers that are positioned to enable contact between the solution and the article at a sufficient temperature and for a time calculated to infuse the reactive monomer solution to the article. These dispensers may be a series of atomizing nozzles that create a fine mist covering the surface of the article to be treated, or alternatively, a manifold directing the flow of the reactive monomer mixture over the surface of the article. An advantage of this embodiment of the invention over immersion in a reactive monomer mixture is the great reduction, often by a factor of 10, of the quantity of the monomer mixture needed to treat large articles. The limited quantity of reactive monomer solution needed makes it possible to also reduce the size of the ancillary equipment, such as pumps and heaters.

It should be noted that in this embodiment of the inventive process, the article to be treated is at no time immersed in the heated solvent mixture. Excess solution which may drip from the plastic article is collected at the bottom of the first compartment containing the article being treated and is transferred back to the second compartment where the solution is brought back to the starting temperature and recycled. The recycling process is continued until the plastic article is infused with the desired level of monomer mixture. Following infusion via this method, the treated article can be cured via UV exposure as described. This process may also be designed so that after the article has been treated, the equipment (e.g., atomizing nozzles) is used to deliver a high pressure liquid spray or gas jet to remove excess reactive monomer solution from the treated article's surface.

The surface properties of the plastic articles may be manipulated and, to an extent, controlled via monomer choice and processing times. This modification is dependent upon the article and the chosen monomer, and may include changes in the barrier properties, color, mechanical properties, and chemical reactivity, among others.

The polymeric material may include one or more additives known in the art for their function in the context of these materials. Such additives may include mold release agents, fillers, reinforcing agents (in the form of fibers or flakes, most notably, metal flakes, such as, aluminum flakes and/or glass) flame retardant agents, light-diffusing agents pigments and opacifying agents, such as, titanium dioxide and the like, drip suppressants such as polytetrafluoroethylene, impact modifiers, UV-stabilizers, hydrolytic stabilizers and thermal stabilizers.

The plastic article may be a molded plastic article, which is prepared by art-recognized methods. Molding methods include, for example compression molding, injection molding, rotational molding, extrusion, injection and extrusion blow molding, fiber spinning, and casting. The plastic articles may be any of large variety of items including such as are useful in the optical, electronics, automotive, entertainment, sporting goods, and medical sectors. The molded plastic article may be selected from shaped articles, films (e.g., having a thickness of less than 30 mils (762 μm), and sheets (e.g., having a thickness of greater than or equal to 30 mils (762 μm). Examples of shaped molded plastic articles include, optical lenses, ophthalmic lenses, sunshade lenses, face shields and glazings (e.g., windows in transportation vehicles, such as cars, trucks and aircraft, and windows in residential and commercial buildings). Further examples of molded plastic articles include: computer face-plates; keyboards; bezels and cellular phones; color coded packaging and containers of all types; residential and commercial lighting fixtures and components therefore; sheets, e.g., used in building and in construction; tableware, including plates, cups and eating utensils; small appliances and their components; as well as biosensors, explosive detectors, decorative films, including films such as are intended for use in film insert molding and/or electronics. The plastic article can also be any type of sport equipment such as golf balls or athletic shoes or athletic shoe parts, such as shoe soles, mid-soles, uppers, bladders and energy-absorbing pads.

The present invention may be more fully understood with reference to the examples set forth below. The examples are in no way to be considered as limiting, but instead are provided as illustrative of the invention.

### EXAMPLES

The present invention is further illustrated, but is not to be limited, by the following examples. Specimens of thermoplastic polyurethane (TEXIN elastomer, a product of Bayer MaterialScience) were injection molded to produce slabs of varying thickness as noted below.

Unless otherwise noted, these plastic articles were infused with monomer and initiator by immersion in a solution of 1 wt. % 2,2-dimethoxy-1,2-diphenylethan-1-one and 99 wt. % ethylene glycol dimethacrylate (EGDMA). The infused articles were thoroughly dried. The dried, infused articles were irradiated with a broadband (peak wavelength 365 nm) UV light source at room temperature while under constant nitrogen flow within a closed chamber. The surface layer interpenetrating network was visually apparent under crossed polarizers via optical microscopy. Interpenetrating network layers varied between 10 and 500 μm thick depending on the length of soak time of the article in the solution, the solution temperature, and the particular formulation of thermoplastic polyurethane chosen.

### Example 1

A 3.2 mm thick, injection-molded slab of a TEXIN thermoplastic polyurethane was immersed in the monomer/initiator solution at a temperature of 22° C. for 5 minutes, dried, and exposed to a 4.0 Watt, 365 nm ultraviolet light source at a distance of 7.5 cm for 25 minutes in an oxygen-depleted chamber. The sample was cross-sectioned perpendicular to its original surface, and the interpenetrating network layer was observed in a polarizing light microscope as a slightly birefringent surface layer of thickness 45+−10 μm. Following the same procedure, except with a longer (20 minute) soak time in the monomer/initiator mixture, produced a surface interpenetrating network layer of thickness about 180±10 μm. Following the same procedure except with a 20 minute soak time in the monomer/initiator mixture at a temperature of 60° C. produced a surface IPN layer of thickness about 400±20 μm.

### Example 2

A film of a TEXIN thermoplastic polyurethane (thickness 0.5 mm) was immersed in the monomer/initiator solution at a temperature of 22° C. for 5 minutes, dried, and exposed to a 4.0 Watt, 365 nm ultraviolet light source at a distance of 7.5 cm for 25 min. in an oxygen-depleted chamber. The sample was cross-sectioned perpendicular to its original surface, and the interpenetrating network layer was observed in a polarizing light microscope as a slightly birefringent surface layer of thickness 70±10 μm. The Young's modulus measured by standard tensile testing increased by about a factor of 3 after the treatment.

The diffusion of certain aliphatic hydrocarbons into the treated thermoplastic polyurethane was noticeably slowed, as determined by soaking the material in hexanes at 20° C. for an extended time. Enhancements in hydrocarbon barrier properties were also noted if hydroxyethylmethacrylate (HEMA) was substituted for EGDMA.

### Example 3

A 3.2 mm thick, injection-molded slab of a TEXIN thermoplastic polyurethane was immersed in a solution of 1 wt. % 2,2-dimethoxy-1,2-diphenylethan-1-one and 99 wt. % 2-hydroxyethylmethacrylate (HEMA) at a temperature of 22° C. for 20 minutes, dried, and exposed to a 4.0 Watt, 365 nm ultraviolet light source at a distance of 7.5 cm for 25 minutes in an oxygen-depleted chamber. The treated material and an untreated control sample were immersed in hexanes at 20° C. The initial rate of mass uptake (within the first 16 hours) in the thermoplastic polyurethane slab due to absorption of hexanes was reduced by about a factor of 5 in the treated material, as compared to the untreated control sample.

### Example 4

The surface layer of a thermoplastic polyurethane treated with a solution of 1 wt. % 2,2-dimethoxy-1,2-diphenylethan-1-one and 99 wt. % EGDMA was polymerized by UV exposure through a photomask to create a raised interpenetrating network pattern, visible with the unaided eye, within the surface. The surface layer of a thermoplastic polyurethane slab infused with a solution of 1 wt. % 2,2-dimethoxy-1,2-diphenylethan-1-one and 99 wt. % HEMA was polymerized by UV exposure through a photomask to create a patterned interpenetrating blend, visible with the unaided eye as a raised pattern on the surface after drying of the slab in air. The photopatterned interpenetrating blend regions in some cases showed selectivity for the absorption of organic dyes from solution, demonstrating a significant difference in barrier properties between the interpenetrating blend and the substrate. Haptics (textures) may be created in the same manner using photopatterning.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A plastic article comprising:
a first polymer; and
an interpenetrating network or blend of a second polymer infused in a surface layer of the first polymer,
wherein the second polymer is the product of photopolymerizing, in a de-oxygenated environment, a reactive monomer in the presence of one or more radical photoinitiators.

2. The plastic article according to claim 1, wherein the first polymer comprises at least one member selected from the group consisting of thermoplastic and thermoset polycarbonates, polyesters, polyester polycarbonate copolymers and blends, polyethylene glycol, polymethylmethacrylate, (co)polyesters, aliphatic polycarbonate, styrene, styrene acrylonitrile, acrylonitrile-butadiene-styrene, acrylic polymers, polyurethanes, nylon, polyvinylalcohols, plasticized polyvinylchlorides and blends of one or more of these resins.

3. The plastic article according to claim 1, wherein the first polymer is a thermoplastic polyurethane.

4. The plastic article according to claim 1, wherein the reactive monomer is selected from the group consisting of acrylic acid, methyl acrylate, n-butyl acrylate, pentaerythritol triacrylate, 1,10-decanediol dimethacrylate, 1,4-butanediol dimethacrylate, n-butoxyethyl methacrylate, cyclohexyl methacrylate, 1,6-hexanediol dimethacrylate, 1,9-decanediol dimethacrylate, diethylaminoethyl methacrylate, dimethylaminoethyl methacrylate, ethylene glycol dimethacrylate, glycidyl methacrylate, isobornyl methacrylate, methyl methacrylate, n-hexyl methacrylate, hydroxyethyl methacrylate, methyl acrylate, 2-hydroxy-3-acryloxy propyl methacrylate, 2-hydroxybutyl methacrylate, 2-hydroxy propyl methacrylate, lauryl methacrylate, perfluorooctylethyl methacrylate, 2-phenoxy ethyl methacrylate, stearyl methacrylate, trifluoroethyl methacrylate and methacrylic acid.

5. The plastic article according to claim 1, wherein the one or more radical photoinitiators selected from the group consisting of 2-hydroxy-1-phenyl-propan-1-one, 1-hydroxy-cyclohexyl-phenyl-ketone, 2-hydroxy-1-{4-[4-(2-hydroxy-2-methyl-propionyl)-benzyl]-phenyl}-2-methyl-propan-1-one, 2-benzyl-2-dimethylamino-1-(4-morpholinophenyl)-butanone-1,2,2-dimethoxy-1,2-diphenylethan-1-one, bis(2,6-dimethoxybenzoyl-2,4,4-trimethyl pentylphosphineoxide, phenylbis(2,4,6-trimethylbenzoyl)-phosphine oxide, 1-[4-(2-hydroxyethoxy)-phenyl]-2-hydroxy-2-methyl-1-propane-1-one, benzophenone, 2-dimethylamino-2-(4-methyl-benzyl)-1-(4-morpholin-4-yl-phenyl)-butan-1-one, 2,2-dimethoxy-1,2-diphenylethan-1-one, oxy-phenyl-acetic acid 2-[2-oxo-2-phenyl-acetoxy-ethoxy]-ethyl ester, oxy-phenyl acetic acid 2-[2-hydroxy-ethoxy]-ethyl ester, bis(2,4,6-trimethylbenzoyl)-phenylphosphineoxide, bis-acyl-phosphine oxide, 2-methyl-1 [4-(methylthio)phenyl]-2-morpholinopropan-1-one, 1,2-octanedione, and 1-[4-(phenylthio)phenyl]-,2-(O-benzoyloxime).

6. The plastic article according to claim 1, wherein the plastic article is a shaped molded plastic article selected from the group consisting of optical lenses, ophthalmic lenses, sunshade lenses, face shields, glazings, computer face-plates; keyboards; bezels, cellular phones; packaging, containers, residential and commercial lighting fixtures and components therefore, sheets used in building and in construction, tableware, small appliances and their components, biosensors, explosive detectors, decorative films, golf balls, athletic shoes, athletic shoe soles, athletic shoe mid-soles, athletic shoe uppers, athletic shoe bladders, athletic shoe energy-absorbing pads.

7. The plastic article according to claim 1, wherein the article includes one or more additives selected from the group consisting of mold release agents, fillers, reinforcing agents, flame retardant agents, light-diffusing agents, pigments and opacifying agents, drip suppressants, impact modifiers, ultraviolet (UV)-stabilizers, hydrolytic stabilizers and thermal stabilizers.

8. A process for producing one of an interpenetrating network and an interpenetrating blend in a surface layer of a plastic article, the process comprising:
a) contacting the plastic article with a solution containing at least one reactive monomer and one or more radical photoinitiators for a time and at a temperature sufficient to infuse at least a portion of the solution into the surface layer of the plastic article; and
b) photopolymerizing the infused solution in a de-oxygenated environment to produce the interpenetrating network or blend in the surface layer of the plastic article.

9. The process according to claim 8, wherein the solution comprises from about 0.01 mass % to about 10.0 mass % of radical photoinitiator and from about 90.0 mass % to about 99.99 mass % of monomer.

10. The process according to claim 8, wherein the solution comprises from about 0.1 mass % to about 3.0 mass % of radical photoinitiator and from about 97.0 mass % to about 99.9 mass % of monomer.

11. The process according to claim 8, wherein the plastic article comprises at least one member selected from the group consisting of thermoplastic and thermoset polycarbonates, polyesters, polyester polycarbonate copolymers and blends, polyethylene glycol, polymethylmethacrylate, (co)polyesters, aliphatic polycarbonate, styrene, styrene acrylonitrile, acrylonitrile-butadiene-styrene, acrylic polymers, polyurethanes, nylon, polyvinylalcohols, plasticized polyvinylchlorides and blends of one or more of these resins.

12. The process according to claim 8, wherein the plastic article comprises a thermoplastic polyurethane.

13. The process according to claim 8, wherein the reactive monomer is selected from the group consisting of acrylic acid, methyl acrylate, n-butyl acrylate, pentaerythritol triacrylate, 1,10-decanediol dimethacrylate, 1,4-butanediol dimethacrylate, n-butoxyethyl methacrylate, cyclohexyl methacrylate, 1,6-hexanediol dimethacrylate, 1,9-decanediol dimethacrylate, diethylaminoethyl methacrylate, dimethylaminoethyl methacrylate, ethylene glycol dimethacrylate, glycidyl methacrylate, isobornyl methacrylate, methyl methacrylate, n-hexyl methacrylate, hydroxyethyl methacrylate, methyl acrylate, 2-hydroxy-3-acryloxy propyl methacrylate, 2-hydroxybutyl methacrylate, 2-hydroxy propyl methacrylate, lauryl methacrylate, perfluorooctylethyl methacrylate, 2-phenoxy ethyl methacrylate, stearyl methacrylate, trifluoroethyl methacrylate and methacrylic acid.

14. The process according to claim 8, wherein the one or more radical photoinitiators is selected from the group consisting of 2-hydroxy-1-phenyl-propan-1-one, 1-hydroxy-cyclohexyl-phenyl-ketone, 2-hydroxy-1-{4-[4-(2-hydroxy-2-methyl-propionyl)-benzyl]-phenyl}-2-methyl-propan-1-one, 2-benzyl-2-dimethylamino-1-(4-morpholinophenyl)-butanone-1,2,2-dimethoxy-1,2-diphenylethan-1-one, bis(2,6-dimethoxybenzoyl-2,4,4-trimethyl pentylphosphineoxide, phenylbis(2,4,6-trimethylbenzoyl)-phosphine oxide, 1-[4-(2-hydroxyethoxy)-phenyl]-2-hydroxy-2-methyl-1-propane-1-one, benzophenone, 2-dimethylamino-2-(4-methyl-benzyl)-1-(4-morpholin-4-yl-phenyl)-butan-1-one, 2,2-dimethoxy-1,2-diphenylethan-1-one, oxy-phenyl-acetic acid 2-[2-oxo-2-phenyl-acetoxy-ethoxy]-ethyl ester, oxy-phenyl acetic acid 2-[2-hydroxy-ethoxy]-ethyl ester, bis(2,4,6-trimethylbenzoyl)-phenylphosphineoxide, bis-acyl-phosphine oxide, 2-methyl-1[4-(methylthio)phenyl]-2-morpholinopropan-1-one, 1,2-octanedione, and 1-[4-(phenylthio)phenyl]-,2-(O-benzoyloxime).

15. The process according to claim 8, wherein the plastic article is a shaped molded plastic article selected from the group consisting of optical lenses, ophthalmic lenses, sunshade lenses, face shields, glazings, computer face-plates; keyboards; bezels, cellular phones; packaging, containers, residential and commercial lighting fixtures and components therefore, sheets used in building and in construction, tableware, small appliances and their components, biosensors, explosive detectors, decorative films, golf balls, athletic shoes, athletic shoe soles, athletic shoe mid-soles, athletic shoe uppers, athletic shoe bladders, athletic shoe energy-absorbing pads.

16. The process according to claim 8 further including adding one or more additives selected from the group consisting of mold release agents, fillers, reinforcing agents, flame retardant agents, light-diffusing agents, pigments and opacifying agents, drip suppressants, impact modifiers, ultraviolet (UV)-stabilizers, hydrolytic stabilizers and thermal stabilizers.

17. The process according to claim 8, wherein the step of contacting is selected from the group consisting of immersing, spraying, and flow-coating.

18. The process according to claim 8, wherein the temperature of contacting is from about 20° C. to about 80° C.

19. The process according to claim 8, wherein the time of contacting is less than about one hour.

20. The process according to claim 8, wherein the time of contacting is from about 0.1 to about 20 minutes.

21. The process according to claim 8, wherein the step of photopolymerizing comprises exposure of the plastic article to ultraviolet (UV) radiation.

22. The process according to claim 21, wherein the exposure is for about 30 seconds to about 10 minutes.

23. The process according to claim 21, wherein the exposure is for about 1 minute to about 5 minutes.

24. A process for producing one of an interpenetrating network pattern and an interpenetrating blend pattern in a surface layer of a plastic article, the process comprising:
a) contacting the plastic article with a solution containing at least one reactive monomer and one or more radical photoinitiators for a time and at a temperature sufficient to infuse at least a portion of the solution into the surface layer of the plastic article;
b), photo-masking at least a portion of the plastic article; and
c) photopolymerizing the infused solution in a de-oxygenated environment to produce the interpenetrating network pattern or interpenetrating blend pattern in the surface layer of the plastic article.

25. The process according to claim 24, wherein the solution comprises from about 0.01 mass % to about 10.0 mass % of radical photoinitiator and from about 90.0 mass % to about 99.99 mass % of monomer.

26. The process according to claim 24, wherein the solution comprises from about 0.1 mass % to about 3.0 mass % of radical photoinitiator and from about 97.0 mass % to about 99.9 mass % of monomer.

27. The process according to claim 24, wherein the plastic article comprises at least one member selected from the group consisting of thermoplastic and thermoset polycarbonates, polyesters, polyester polycarbonate copolymers and blends, polyethylene glycol, polymethylmethacrylate, (co)polyesters, aliphatic polycarbonate, styrene, styrene acrylonitrile, acrylonitrile-butadiene-styrene, acrylic polymers, polyurethanes, nylon, polyvinylalcohols, plasticized polyvinylchlorides and blends of one or more of these resins.

28. The process according to claim 24, wherein the plastic article comprises a thermoplastic polyurethane.

29. The process according to claim 24, wherein the reactive monomer is selected from the group consisting of acrylic acid, methyl acrylate, n-butyl acrylate, pentaerythritol triacrylate, 1,10-decanediol dimethacrylate, 1,4-butanediol dimethacrylate, n-butoxyethyl methacrylate, cyclohexyl methacrylate, 1,6-hexanediol dimethacrylate, 1,9-decanediol dimethacrylate, diethylaminoethyl methacrylate, dimethylaminoethyl methacrylate, ethylene glycol dimethacrylate, glycidyl methacrylate, isobornyl methacrylate, methyl methacrylate, n-hexyl methacrylate, hydroxyethyl methacrylate, methyl acrylate, 2-hydroxy-3-acryloxy propyl methacrylate, 2-hydroxybutyl methacrylate, 2-hydroxy propyl methacrylate, lauryl methacrylate, perfluorooctylethyl methacrylate, 2-phenoxy ethyl methacrylate, stearyl methacrylate, trifluoroethyl methacrylate and methacrylic acid.

30. The process according to claim 24, wherein the one or, more radical photoinitiators is selected from the group consisting of 2-hydroxy-1-phenyl-propan-1-one, 1-hydroxy-cyclohexyl-phenyl-ketone, 2-hydroxy-1-{4-[4-(2-hydroxy-2-methyl-propionyl)-benzyl]-phenyl}-2-methyl-propan-1-one, 2-benzyl-2-dimethylamino-1-(4-morpholinophenyl)-butanone-1, 2,2-dimethoxy-1,2-diphenylethan-1-one, bis(2,6-dimethoxybenzoyl-2,4,4-trimethyl pentylphosphineoxide, phenylbis(2,4,6-trimethylbenzoyl)-phosphine oxide, 1-[4-(2-hydroxyethoxy)-phenyl]-2-hydroxy-2-methyl-1-propane-1-one, benzophenone, 2-dimethylamino-2-(4-methyl-benzyl)-1-(4-morpholin-4-yl-phenyl)-butan-1-one, 2,2-dimethoxy-1,2-diphenylethan-1-one, oxy-phenyl-acetic acid 2-[2-oxo-2-phenyl-acetoxy-ethoxy]-ethyl ester, oxy-phenyl acetic acid 2-[2-hydroxy-ethoxy]-ethyl ester, bis(2,4,6-trimethylbenzoyl)-phenylphosphineoxide, bis-acyl-phosphine oxide, 2-methyl-1[4-(methylthio)phenyl]-2-morpholinopropan-1-one, 1,2-octanedione, and 1-[4-(phenylthio) phenyl]-,2-(O-benzoyloxime).

31. The process according to claim 24, wherein the plastic article is a shaped molded plastic article selected from the group consisting of optical lenses, ophthalmic lenses, sunshade lenses, face shields, glazings, computer face-plates; keyboards; bezels, cellular phones; packaging, containers, residential and commercial lighting fixtures and components therefore, sheets used in building and in construction, tableware, small appliances and their components, biosensors, explosive detectors, decorative films, golf balls, athletic shoes, athletic shoe soles, athletic shoe mid-soles, athletic shoe uppers, athletic shoe bladders, athletic shoe energy-absorbing pads.

32. The process according to claim 24 further including adding one or more additives selected from the group consisting of mold release agents, fillers, reinforcing agents, flame retardant agents, light-diffusing agents, pigments and opacifying agents, drip suppressants, impact modifiers, ultraviolet (UV)-stabilizers, hydrolytic stabilizers and thermal stabilizers.

33. The process according to claim 24, wherein the step of contacting is selected from the group consisting of immersing, spraying, and flow-coating.

34. The process according to claim 24, wherein the temperature of contacting is from about 20° C. to about 80° C.

35. The process according to claim 24, wherein the time of contacting is less than about one hour.

36. The process according to claim 24, wherein the time of contacting is from about 0.1 to about 20 minutes.

37. The process according to claim 24, wherein the step of photopolymerizing comprises exposure of the plastic article to ultraviolet (UV) radiation.

38. The process according to claim 37, wherein the exposure is for about 30 seconds to about 10 minutes.

39. The process according to claim 37, wherein the exposure is for about 1 minute to about 5 minutes.

40. A process for producing one of an interpenetrating network haptic (texture) and an interpenetrating blend haptic (texture) in a surface layer of a plastic article, the process comprising:
a) contacting the plastic article with a solution containing at least one reactive monomer and one or more radical photoinitiators for a time and at a temperature sufficient to infuse at least a portion of the solution into the surface layer of the plastic article;
b) photo-masking at least a portion of the plastic article; and
c) photopolymerizing the infused solution in a de-oxygenated environment to produce the interpenetrating network pattern or interpenetrating blend pattern in the surface layer of the plastic article.

41. The process according to claim 40, wherein the solution comprises from about 0.01 mass % to about 10.0 mass % of radical photoinitiator and from about 90.0 mass % to about 99.99 mass % of monomer.

42. The process according to claim 40, wherein the solution comprises from about 0.1 mass % to about 3.0 mass % of radical photoinitiator and from about 97.0 mass % to about 99.9 mass % of monomer.

43. The process according to claim 40, wherein the plastic article comprises at least one member selected from the group consisting of thermoplastic and thermoset polycarbonates, polyesters, polyester polycarbonate copolymers and blends, polyethylene glycol, polymethylmethacrylate, (co)polyesters, aliphatic polycarbonate, styrene, styrene acrylonitrile, acrylonitrile-butadiene-styrene, acrylic polymers, polyurethanes, nylon, polyvinylalcohols, plasticized polyvinylchlorides, olefins, and blends of one or more of these resins.

44. The process according to claim 40, wherein the plastic article comprises a thermoplastic polyurethane.

45. The process according to claim 40, wherein the reactive monomer is selected from the group consisting of acrylic acid, methyl acrylate, n-butyl acrylate, pentaerythritol triacrylate, 1,10-decanediol dimethacrylate, 1,4-butanediol dimethacrylate, n-butoxyethyl methacrylate, cyclohexyl methacrylate, 1,6-hexanediol dimethacrylate, 1,9-decanediol dimethacrylate, diethylaminoethyl methacrylate, dimethylaminoethyl methacrylate, ethylene glycol dimethacrylate, glycidyl methacrylate, isobornyl methacrylate, methyl methacrylate, n-hexyl methacrylate, hydroxyethyl methacrylate, methyl acrylate, 2-hydroxy-3-acryloxy propyl methacrylate, 2-hydroxybutyl methacrylate, 2-hydroxy propyl methacrylate, lauryl methacrylate, perfluorooctylethyl methacrylate, 2-phenoxy ethyl methacrylate, stearyl methacrylate, trifluoroethyl methacrylate and methacrylic acid.

46. The process according to claim 40, wherein the one or more radical photoinitiators is selected from the group consisting of 2-hydroxy-1-phenyl-propan-1-one, 1-hydroxy-cyclohexyl-phenyl-ketone, 2-hydroxy-1-{4-[4-(2-hydroxy-2-methyl-propionyl)-benzyl]-phenyl}-2-methyl-propan-1-one, 2-benzyl-2-dimethylamino-1-(4-morpholinophenyl)-butanone-1,2,2-dimethoxy-1,2-diphenylethan-1-one, bis(2,6-dimethoxybenzoyl-2,4,4-trimethyl pentylphosphineoxide, phenylbis(2,4,6-trimethylbenzoyl)-phosphine oxide, 1-[4-(2-hydroxyethoxy)-phenyl]-2-hydroxy-2-methyl-1-propane-1-one, benzophenone, 2-dimethylamino-2-(4-methyl-benzyl)-1-(4-morpholin-4-yl-phenyl)-butan-1-one, 2,2-dimethoxy-1,2-diphenylethan-1-one, oxy-phenyl-acetic acid 2-[2-oxo-2-phenyl-acetoxy-ethoxy]-ethyl ester, oxy-phenyl acetic acid 2-[2-hydroxy-ethoxy]-ethyl ester, bis(2,4,6-trimethylbenzoyl)-phenylphosphineoxide, bis-acyl-phosphine oxide, 2-methyl-1[4-(methylthio)phenyl]-2-morpholinopropan-1-one, 1,2-octanedione, and 1-[4-(phenylthio)phenyl]-,2-(O-benzoyloxime).

47. The process according to claim 40, wherein the plastic article is a shaped molded plastic article selected from the group consisting of optical lenses, ophthalmic lenses, sunshade lenses, face shields, glazings, computer face-plates; keyboards; bezels, cellular phones; packaging, containers, residential and commercial lighting fixtures and components therefore, sheets used in building and in construction, tableware, small appliances and their components, biosensors, explosive detectors, decorative films, golf balls, athletic shoes, athletic shoe soles, athletic shoe mid-soles, athletic shoe uppers, athletic shoe bladders, athletic shoe energy-absorbing pads.

48. The process according to claim 40 further including adding one or more additives selected from the group consisting of mold release agents, fillers, reinforcing agents, flame retardant agents, light-diffusing agents, pigments and opacifying agents, drip suppressants, impact modifiers, ultraviolet (UV)-stabilizers, hydrolytic stabilizers and thermal stabilizers.

49. The process according to claim 40, wherein the step of contacting is selected from the group consisting of immersing, spraying, and flow-coating.

50. The process according to claim 40, wherein the temperature of contacting is from about 20° C. to about 80° C.

51. The process according to claim 40, wherein the time of contacting is less than about one hour.

52. The process according to claim 40, wherein the time of contacting is from about 0.1 to about 20 minutes.

53. The process according to claim 40, wherein the step of photopolymerizing comprises exposure of the plastic article to ultraviolet (UV) radiation.

54. The process according to claim 53, wherein the exposure is for about 30 seconds to about 10 minutes.

55. The process according to claim 53, wherein the exposure is for about 1 minute to about 5 minutes.
